(19) United States
(12) Patent Application Publication
(10) Pub. No.: US 2020/0005198 A1
(43) Pub. Date: Jan. 2, 2020

(54) NETWORK COMPUTER SYSTEM TO IMPLEMENT ADDITIVE SERVICE VALUES FOR SERVICE PROVIDERS

(71) Applicant: Uber Technologies, Inc., San Francisco, CA (US)

(72) Inventors: Hamid Nazerzadeh, San Francisco, CA (US); Carter Mundell, San Francisco, CA (US); SHICONG MENG, San Francisco, CA (US); Whitney Chu, San Franciscco, CA (US); Ken Chong, San Francisco, CA (US); Qitang Wang, San Francisco, CA (US); Parijat Mazaumdar, San Francisco, CA (US); Connor Soltas, San Francisco, CA (US); Calvin Li, San Francisco, CA (US); Rei Chiang, San Francisco, CA (US); Awaneesh Verma, San Francisco, CA (US); Peter Cohen, San Francisco, CA (US)

(21) Appl. No.: 16/419,991

(22) Filed: May 22, 2019

Related U.S. Application Data
(60) Provisional application No. 62/675,159, filed on May 22, 2018.

(51) Int. Cl. G06Q 10/02; G06Q 30/02; G06Q 10/06; G06Q 50/30

(52) U.S. Cl. CPC G06Q 10/02; G06Q 30/0207; G06Q 50/30; G06Q 10/06315; G06Q 30/0205

(57) ABSTRACT

A network computer system operates to monitor a plurality of requester devices to detect activities of requesters, and activities of transportation providers. Based on the monitored activities, the system forecasts a number of requesters that may be present in each of multiple subregions of a given geographic region, during an upcoming time interval. The system further estimates a target number of transportation providers to have available for requesters in each of the subregions. The system determines a supplemental value set for crediting transportation providers, in connection with each individual transport provider performing one or more activities that make the transport provider available to one or more of the multiple subregions during the upcoming time interval.

### RELATED APPLICATIONS

This application claims benefit of priority to provisional U.S. Patent Application No. 62/675,159, filed May 22, 2018; the aforementioned priority application being hereby incorporated by reference in its entirety.

### BACKGROUND

Network computer systems exist to provide various types of services using mobile devices. These services are sometimes de-centralized or distributed, causing inefficiencies to occur with respect to the use of resources, including computing resources.

### BRIEF DESCRIPTION OF THE DRAWINGS

FIG. 1 illustrates an example computer system for providing transport arrangement services.

FIGS. 2A-C illustrates example user interfaces for a service provider application compatible with a network service system.

FIG. 3A and FIG. 3B illustrate example methods for providing information about supplemental values associated with corresponding subregions in a given geographic region, where the supplemental values are based on a forecasted deficiency in the provisioning of the corresponding subregion.

FIG. 4 describes an example method of additive service values for service providers, in accordance with some aspects.

FIG. 5 describes an example method of supply forecasting in a decoupled, provider-based additive reward system, in accordance with some aspects.

FIG. 6 illustrates a computer system upon which aspects described herein may be implemented.

FIG. 7 is a block diagram that illustrates a mobile device upon which examples described herein may be implemented.

### DETAILED DESCRIPTION

A network computer system operates to provide a network service, where demand and supply for the network service are forecast and planned for, resulting in more efficient use of resources of the network computer system.

According to examples, a network computer system operates to monitor a plurality of requester devices to detect activities of requesters, and activities of transportation providers. Based on the monitored activities, the system forecasts a number of requesters that may be present in each of multiple subregions of a given geographic region, during an upcoming time interval. The system further estimates a target number of transportation providers to have available for requesters in each of the subregions. The system determines a supplemental value set for crediting transportation providers, in connection with each individual transport provider performing one or more activities that make the transport provider available to one or more of the multiple subregions during the upcoming time interval.

In examples, a network computer system operates to implement an on-demand service. The implementation of the on-demand service may include executing and managing numerous processes and workflows, for purpose of providing a highly-interactive and seamless experience to users. Some on-demand services utilize information and input from a population of users, each of which operate a corresponding mobile computing device. For such services, the population of users include requesters (e.g., riders) and service providers (e.g., drivers), and the network computer system implements processes to aggregate information from the population of users, while providing instructions and content relating to requested or provided services to the mobile computing devices of the users.

In the context of an on-demand transport services, a network computer system can operate to automate many of the tasks which a requester or service provider would otherwise have to perform. Moreover, the network computer system may utilize a distributed set of user devices (e.g., mobile computing devices operated by individual users) to optimize aspects of the on-demand service for a group objective. For example, a network computer system can operate to optimize a metric (e.g., wait time, travel time) for a group of requesters as a whole, such that the objective of the optimization may be to lower the average wait time amongst the group of users, as opposed to optimizing the wait time for individual users of the group, one at a time. In order to implement such optimization, a network computer system typically coordinates the implementation of numerous programmatic processes, executing in a distributed system, in order to achieve a result where the average wait time for requesters in, for example, a given city block is significantly reduced as compared to an alternative implementation where no group optimization is performed. In this regard, on-demand services leverage technological developments (e.g., use of microservices and distributed computing platforms) to provide transport services more efficiently than more conventional approaches, where there would otherwise be minimal ability to implement any type of group optimization.

A key technological challenge for on-demand services is supply provisioning. In this challenge, the network computer system typically implements operations to determine at least one of an amount of supply or demand at multiple locations throughout a geographic region. The network computer system may further implement operations to provision for the determined demand, where the provisioning includes operations which the network computer system performs to cause a given location to have an adequate number of service providers to meet the determined demand.

In implementing an on-demand service, a network computer system typically utilizes a distributed platform where the mobile devices of the users are used for a variety of purposes. For service providers, the network computer system may communicate instructions, content or other information to their mobile devices to cause a desired response, where the desired response may involve the service provider performing an action that does not involve direct interaction with the mobile device. In examples, a responsive action such as the service provider driving in a particular direction can be tracked using, for example, a satellite receiver of the service provider's mobile device. Through communications and monitoring, some on-demand services can impact the provisioning levels of various locations in a given geographic area. For example, a network computer system can communicate content that includes incentives for the service provider to travel to a given subregion. In some prior approaches, a network computer system publishes a heatmap at a given frequency, where the heatmap identifies subregions of a geographic region where the service provider may receive the most use and reward for their services.

Previous approaches to the problem of balancing demand and supply in a network service system have numerous inefficiencies and drawbacks. One solution, surge pricing, was designed to solve a reliability problem for requesters by using price to turn excess requesters away. In this approach, a network computer system operates to first suppress demand and then move supply. However, one disadvantage to this approach is the degradation of the experience for service providers because requesters and providers make decisions based on different time horizons. Since surge was designed with demand as the focus, the experience isn't intuitive or predictable for service providers. Some problems service providers encountered with previous solutions such as surge include:

Lack of Provider Control—Providers have no control over where a requester requests. Even if they are in a surge area, a provider could be dispatched to a lower or non-surge subregion that is nearby in order to fulfill a newly received service request. Without the ability to control the service locations of the incoming service requests, service providers lose motivation to drive near or into a surge subregion, where the ratio of supply to demand may be the lowest.

Difficult to Achieve—It takes time to move throughout a city. Under prior solutions, updates to heatmaps may be communicated to quickly, causing service providers to frequently change bearings or focus. A heatmap that updates too frequently can often change too quickly for service providers to react as desired (e.g., reach surge), making the heatmap less effective and the service provider's use of their mobile device less efficient.

Not Related to Effort—Service providers do not have control over a requester's trip. In a multiplicative implementation where service providers are credited based on a multiplier that reflects demand or undersupply, a 1.5× multiplier could range anywhere from $3 to $50 in surge, effectively creating a lottery. With this uncertainty, it is difficult for a service provider to decide whether or not it is worth their time, effort, and money to relocate to a surging area. This type of indecision makes the network computer system's provisioning determinations and operations less efficient.

Not only do previous solutions create a suboptimal provider experience, they also create a mental model where providers tie the value of surge with the length of a service request rather than the location of the request. This leads to inefficiencies since one goal of variable rewards is to encourage higher supply at undersupplied locations.

Accordingly, examples include a network computer system to implement a decoupled, provider-based additive reward system to alleviate the provider challengers under prior approaches. Among other benefits, an example network computer system generates communications and incentives which result in a more predictable response from a service provider, and the network computer system is better able to provision supply for forecasted demand and undersupply in a given geographic region. In doing so, the network computer system provides a better experience for service requesters in times of undersupply than otherwise possible through traditional approaches. For example, group optimization operations can be implemented more efficiently and reliably, to better reduce metrics such as overall wait time to service requesters. When service providers are positioned more effectively during times of high demand, requesters can experience fewer instances of increased costs and long wait times.

In examples, a network service system is provided to decouple supply-side incentives given to providers from demand-side disincentives. In examples, the network computer system operates to position service providers at locations that maximize network value and efficient operation.

In other examples, the network computer system operates to distribute a heatmap which is effective and reliable for receiving service providers. Service providers may have their heatmaps refresh at a rate that is dependent on the service state of the service provider, such that service providers who actively use the heatmap can more easily operate their vehicles to further a desired objective of the network computer system.

In examples, a network computer system credits service providers based on supplemental values which are individually associated with subregions and locations of a geographic region. When the service provider is available, the service provider can travel to, through or within subregions to earn credit that is based on supplemental values for one or more of the subregions. In examples, when the service provider performs the desired activities for multiple subregions (e.g., travel to or through the respective subregions), the service provider is awarded credit based on one or more rules that determine or otherwise select the supplemental value from multiple supplemental values which the service provider encountered while operating the service vehicle and being available, or other being in another designated service state. The selected supplemental value may, for example, coincide with the largest supplemental value that the service provider encountered while operating the service vehicle in the available state.

Still further, in other examples, the network computer system may implement persistent (or “sticky”) supplemental values which may be defined based on geographic constraints, timing constraints, or other rules or conditions. For example, the network computer system may implement persistent supplemental values such that when the heatmap refreshes while the provider is online (after a predetermined amount of time), the service provider will retain the highest value they previously obtained.

Accordingly, in examples, the network computer system generates supplemental values for subregions of a geographic region. The supplemental values may be associated with a heatmap and a heatmap version. The heatmaps in their respective versions may be communicated to service providers at a frequency or timing that is based on factors such as the service state of the service provider. The network computer system implements processes to track activities of individual service providers to determine the supplemental value that is to be the basis of the additive credit for the service provider. In examples, the network computer system tracks each service provider to determine an earned supplemental value that is specific to the version of the heatmap which the service provider utilizes.

In examples, the supplemental value may be credited to the service provider in a manner that additive, where the supplemental value is based on the subregions where the service provider performed an activity, and the version (e.g., timing) of the heatmap which was provided to the service provider.

Among other benefits, a decoupled, provider-based additive reward system provides a reliable signal for providers deciding how to spend their off-trip time, which results in increased “heatmap elasticity”, e.g., providers' willingness to move towards areas of undersupply. In addition, the system better achieves request-indifference so that providers do not benefit from and are not encouraged to reject requests from undersupplied areas. Ultimately, the system provides value to the user base, not just to providers, but also to service requesters and the network operator.

As used herein, a client device, a computing device, and/or a mobile computing device refer to devices corresponding to desktop computers, cellular devices or smartphones, laptop computers, tablet devices, etc., that can provide network connectivity and processing resources for communicating with a service arrangement system over one or more networks. In another example, a computing device can correspond to an in-vehicle computing device, such as an on-board computer. Also, as described herein, a user can correspond to a requester of a network service (e.g., a requester) or a service provider (e.g., a provider of a vehicle) that provides location-based services for requesters.

Still further, examples described relate to a variety of location-based (and/or on-demand) services, such as a transport service, a food truck service, a delivery service, an entertainment service, etc., to be arranged between requesters and service providers. In other examples, the system can be implemented by any entity that provides goods or services for purchase through the use of computing devices and network(s). For the purpose of simplicity, in examples described, the service arrangement system can correspond to a transport arrangement system that arranges transport and/or delivery services to be provided for requesters by providers of vehicles who operate service applications on respective computing devices.

One or more examples described provide that methods, techniques, and actions performed by a computing device are performed programmatically, or as a computer-implemented method. Programmatically, as used, means through the use of code or computer-executable instructions. These instructions can be stored in one or more memory resources of the computing device. A programmatically performed step may or may not be automatic.

One or more examples described can be implemented using programmatic modules, engines, or components. A programmatic module, engine, or component can include a program, a sub-routine, a portion of a program, or a software component or a hardware component capable of performing one or more stated tasks or functions. As used herein, a module or component can exist on a hardware component independently of other modules or components. Alternatively, a module or component can be a shared element or process of other modules, programs, or machines.

Some examples described can generally require the use of computing devices, including processing and memory resources. For example, one or more examples described may be implemented, in whole or in part, on computing devices such as servers, desktop computers, cellular or smartphones, and tablet devices. Memory, processing, and network resources may all be used in connection with the establishment, use, or performance of any example described herein (including with the performance of any method or with the implementation of any system).

Furthermore, one or more examples described may be implemented through the use of instructions that are executable by one or more processors. These instructions may be carried on a computer-readable medium. Machines shown or described with figures below provide examples of processing resources and computer-readable mediums on which instructions for implementing examples described can be carried and/or executed. In particular, the numerous machines shown with examples described include processor(s) and various forms of memory for holding data and instructions. Examples of computer-readable mediums include permanent memory storage devices, such as hard drives on personal computers or servers. Other examples of computer storage mediums include portable storage units, such as CD or DVD units, flash memory (such as carried on smartphones, multifunctional devices or tablets), and magnetic memory. Computers, terminals, network enabled devices (e.g., mobile devices, such as cell phones) are all examples of machines and devices that utilize processors, memory, and instructions stored on computer-readable mediums. Additionally, examples may be implemented in the form of computer-programs, or a computer usable carrier medium capable of carrying such a program.

System Description

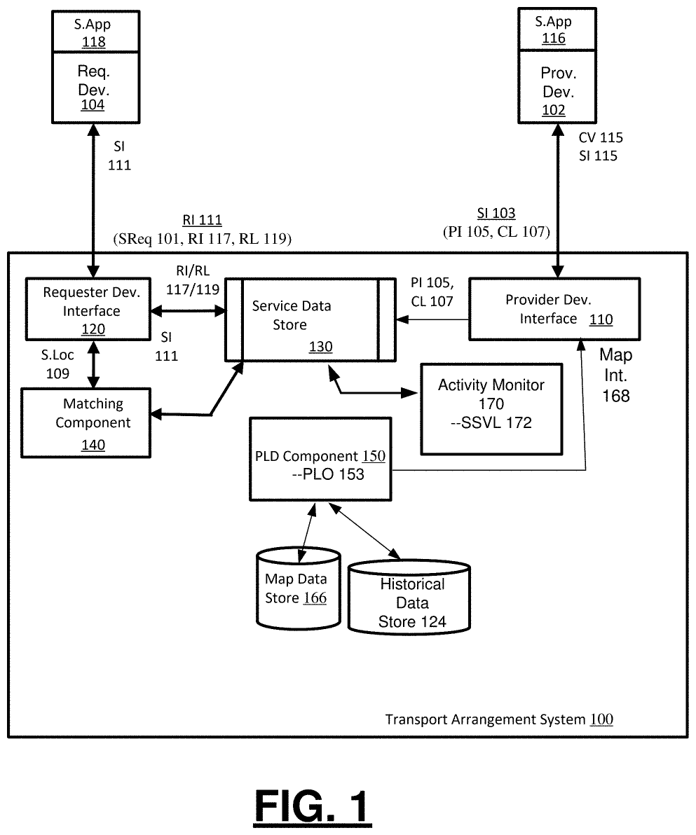

FIG. 1 illustrates an example network computer system for providing transport arrangement services. A network computer system 100 such as shown by FIG. 1 can be implemented in a variety of computing environments, including as part of a network service provided through one or more servers. In some variations, the network computer system 100 is implemented as part of, or in connection with a service arrangement system, where, for example, operators use service vehicles to provide transportation-related services between locations. Still further, some examples provide for the network computer system 100 to be distributed using one or more servers and/or mobile devices. For example, the network computing system 100 can be implemented using mobile devices of users, including service providers and requesters, with the individual devices executing a corresponding service application that causes the computing device to operate as an information inlet and/or outlet for the network computing system 100. In some examples, the system 100 implements a network platform, in connection with applications that run on mobile devices of the population of users. For a given geographic region, the users can include operators (or “service providers”) of service vehicles, as well as requesters who receive a transport-related service.

As described with various examples, the network computer system 100 generates instructions, content and other information which collectively guide service vehicles (represented by service vehicle 10) in accordance with a desired provisioning for the geographic region.

The system 100 includes a provider device interface 110, a requester device interface 120, a service data store 130 and a service matching component 140. The provider device interface 110 includes or performs processes that run on the network-side of the system 100 to establish communication channels with individual devices of service providers. For example, the provider device interface 110 can establish secure sockets with different types of mobile devices which service providers of the system 100 can utilize when providing services using their respective vehicles. In some examples, the service providers operate mobile devices (represented in FIG. 1 by the mobile device 102) on which a corresponding service application 116 runs. Among other functionality, the service application 116 can automate operations which include indicating the availability of the service provider to provide service, communicating location information to enable the system 100 to monitor the location of the service provider's vehicle, receiving information from the system 100 for facilitating the service provider in receiving service requests and fulfilling a service request, and communicating information to the system 100 for various purposes, including provisioning determinations for different geographic subregions of a geographic region.

Likewise, the requester device interface 120 includes or performs processes that run on the network-side of the system 100 to establish communication channels with individual devices of requesters. The requesters may also operate mobile devices (represented in FIG. 1 by the requester device 104) on which a corresponding service application 118 runs. The requesters may operate respective service applications 118 to request transport-related services, such as human transport between a start location (or pickup location) and a destination (or drop-off). In variations, the types of services which may be arranged through the system 100 may include human transport, deliveries, shipping, and delivery of on-demand services (e.g., food trucks). The service application 118 may also provide information for use in enabling the system 100 with determining provisioning levels. For example, the service application 118 may communicate with the system 100 when the requester first opens the application, but before the service requester makes a request for service.

In some examples, the provider device interface 110 and the requester device interface 120 can each include or use an application programming interface (API), such as an externally provider-facing API, to communicate data with the provider and requester devices 102, 104, respectively. By providing the externally facing API, the system 100 can establish secure communication channels via secure access channels over the network through any number of methods, such as web-based forms, programmatic access via RESTful APIs, Simple Object Access Protocol (SOAP), remote procedure call (RPC), scripting access, etc.

According to some examples, the provider device 102 initiates communications with the system 100 using the service application 116. The service application 116 may correspond to a program (e.g., a set of instructions or code) that is downloaded and stored on the mobile device 102 of the service provider. The service provider can launch the service application 116 in order to utilize the system 100 to receive service requests, and the service provider may operate a service vehicle to fulfill assigned service requests. Once the communication channel is established, the provider device 102 may repeatedly or continuously communicate service information 103 to the system 100. The service information 103 may include the provider's identifier 105, and the provider's current location 107, which may be determined by the service application interfacing with a GPS component of the provider device 102.

The service data store 130 maintains the current location 107 of each active service provider at a particular moment. By way of example, each service provider may start a shift by operating the service application 116 (e.g., opening the application on the provider's device 102), and then toggling a state feature provided by the service application 116 to ‘on duty’. The service application 116 communicates the activation of the state feature to the system 100 via the provider device interface 110. The provider device interface 110 processes the service information 103 received from individual service providers. For each service provider, the provider device interface 110 extracts the current location 107 and stores the current location with the provider's identifier 105 in the service data store 130. As the service provider's location changes (e.g., with movement of the service provider's vehicle), subsequent communications from the provider device 102 via the provider device interface 110 can be used to update the service data store 130. In this way, the service data store may reflect the most current location of each service provider.

The service data store 130 may also associate a service state with each provider. Initially, when the service provider goes on duty, the service provider may be associated with an available state. Once the service provider is matched to a service request, the associated state of the service provider may change, to reflect, for example, one more unavailable states (e.g., on-trip, on route to service start, etc.).

The requester device interface 120 receives requester information 111 from multiple requesters. The requester information 111 can identify the requester (e.g., by account), as well as provide the current location of the requester. The requester information 111 can be communicated with a service request 101. In some variations, at least some of the requester information 111 (e.g., current location) may be communicated before the service request 101 is communicated. The requester device interface 120 can parse individual service requests 101 to determine one or more service locations 109 of the service request, including the service start location and/or the service destination location.

In one implementation, the matching component 140 references the service location(s) 109 of an incoming service request 101 with the current location of available service providers, as provided by the service data store 130. In one example, that matching component 140 queries the service data store 130 for service providers that are within a first threshold distance (alternatively, within a threshold time of travel). From the queried result set, the matching component 140 makes a selection of a service provider for the service request 101. The service provider may receive the matched service request as an invitation, or the matched service request may be communicated as an automatic assignment.

Once the service provider is matched to a service request, the matching component 140 changes the service state associated with the selected service provider. For example, a service state of the service provider can be changed from available to unavailable, or from available to on-route to service start location. In the latter example, the service state may change again once service is initiated for the requester. For example, once the requester enters the service vehicle, the service state of the service provider may change to reflect that the service has initiated. Still further, the service provider may interact with the service application 116 to signal that the requester has entered the vehicle. Alternatively, the system 100 may monitor the service vehicle, in order to detect the service vehicle initiating a route towards a destination or other service location. Likewise, requester information 111 can be monitored to detect when the position of the requester device 104 is approximately the same as that of the service provider device 102, while the vehicle of the service providers in motion. Once the service state of the service provider is changed, the service provider can be excluded from possible selection until another event occurs to change the service state again. For example, the current trip for the service provider may complete, or the system 100 may detect when the service vehicle is nearing the destination, such that the service provider can be marked available for assignment to a new service request.

According to some examples, the system 100 includes a provisioning level determination component (“PLD component”) 150 that determines a provisioning level for multiple subregions of a given geographic region. In examples, the PLD component 150 determines a provisioning level output 153 that reflects a comparative measure of service providers and requesters. In examples when the provisioning level output 153 reflects undersupply of service providers, the provisioning level output 153 can reflect a number that represents an estimated deficiency with respect to the number of service providers who are expected to be available for a given region. Thus, for example, the PLD component 150 can determine the provisioning level output 153 by (i) forecasting the number of requesters for a given future time interval, (ii) determining a target number of service providers that are to be present in the geographic region in order for the geographic region to be deemed adequately provisioned, and (iii) projecting the number of actual service providers that are expected to be available in the geographic region during the future time interval. In examples, the adequacy of the provisioning levels can be defined by various metrics, such as the average or median wait time for a requester to receive transport (e.g., duration between when requester makes a service request and when service provider picks up requester), as well as the amount of time in between when a service provider completes a service request and receives a new service request. In examples, the availability of service providers can also be defined by metrics, such as the amount of time a service provider will need to arrive at a pickup location within the geographic region.

The provisioning level output 153 can reflect a provisioning level for each of multiple subregions as either a current (e.g., real-time or near real-time) determination, or as a forecasted determination for a future time interval. In some examples, the provisioning level output 153 may quantify the deficiency as to the number of service providers (e.g., the difference between the projected number of actual service providers and the target number of service providers). In determining the provisioning level output 153, the PLD component 150 may estimate or forecast the actual number of service providers to include any one or more of an estimate of available service providers (e.g., having an unmatched service state), service providers who are on-route to a service location, service providers who are on-trip (or otherwise in a matched state), service providers who are nearing a trip end and can be re-assigned, and/or service providers who are on-trip and are available for further assignment. Likewise, the PLD component 150 may estimate or forecast the requesters to include requesters who have open and unassigned requests, requesters who are being serviced, requesters who have assigned service requests and/or waiting for an assigned service provider, and/or potential requesters (e.g., those users who have opened the service application but who have not yet made a service request).

In determining the provisioning level output 153, the PLD component 150 may utilize historical data 124 to identify, for example, the number of requesters that have historically been present in a given subregion over a comparative time period. The PLD component 150 can estimate or forecast the number requesters for the future time interval to include requesters who have open and unassigned requests, requesters who are being serviced, requesters who have assigned service requests and/or waiting for an assigned service provider, and/or potential requesters. In such example, the potential requesters can include those users who have opened the service application 118 but who have not yet made a service request. Still further, in variations, the projected number of service requesters for the upcoming time interval may be based on a correlation to a quantity and/or location of potential service requesters (e.g., users who have launched or are otherwise running the service application, but who have not yet generated a service request). In such examples, the correlation between potential requesters in a first time interval (e.g., current or prior time interval, such as last ten minutes) and the number of actual requesters for the upcoming time interval can be modeled based on historical data 124. As an addition or variation, the quantity and location of potential service requesters may be weighted or otherwise accounted for, based on a tabulation of users who are present in the relevant geographic region and whom are likely, based on their respective activity, to make a service request.

Likewise, the service data store 130 may identify the number of service providers which have historically been available in or near a given subregion. The service data store 130 may also provide inputs from the current state of the geographic region for use in forecasting. Such inputs may include a current number of service vehicles (e.g., active or on-duty service providers), a current number of requesters, and the current location or subregion of the currently active service providers and/or requesters. In some examples, the PLD component 150 can extrapolate or model a current projection of the number of requesters for a future time interval in each of multiple subregions of a given geographic region, using the historical trip data 124 and inputs determined from the service data store 130 regarding the current numbers of service providers (or their respective vehicles) and requesters (e.g., including users who have open service requests, as well as users who have opened the service application on their respective mobile device 104 but have not yet generated a service request).

In some examples, the provisioning level output 153 may be represented as a score for individual subregions of a larger geographic region, where the score is based on the ratio of service providers and requesters. A map data store 166 may store the provisioning level output 153 (e.g., as a score) for individual subregions. In this way, the provisioning level output 153 may reflect oversupply or undersupply of service providers in specific subregions.

A map interface 168 can reflect a supplemental value set for a geographic region, where the values of the supplemental value set can be redeemed as credit by service providers in connection with the service provider performing an activity that results in the service provider improving the provisioning level during the upcoming time interval. In examples, the credit values are additive to the provider's fare. According to examples, the map interface 168 can publish supplemental values (or credit values based on the supplemental values) in the form of a heat map, which can delineate subregions of a given region, and indicate respective imbalance with respect to a current or forecasted provisioning level (e.g., deficiency in the number of providers) through displayed values (e.g., additive monetary value to fare), as well as colors or other visual graphical features.

The system 100 can track activities performed by the service providers with respect to the subregions that are associated with the supplemental values. An activity monitor 170 can interact with the service data store 130 to track the service provider's movement and positioning efforts. For example, the activity monitor 170 can track the service provider operating a vehicle and traveling towards or through subregions that are deemed deficient of service providers. In such examples, the service provider's completion of the activity can be signified by the service provider reaching a location, in a time interval that is desirable to improve the provisioning level. Specific examples of activities that can be tracked and rewarded to incentivize the provider further include the service provider accepting a service request that will position the service provider in an under-supplied subregion, and/or the service provider remaining in a subregion that is forecasted to be in high-demand. The activity monitor 170 can determine the supplemental value (or credit) that is accredited to the provider's account based at least in part on activity that is deemed to improve the deficiency of service providers in identified subregions. The activity monitor 170 can also determine the supplemental value (or credit) based at least in part on other activities of the service provider, such as (i) changes or updates to the service provider status (e.g., mode selections, offline/online status, etc.), and (ii) service provider trip events, including the service location of a service request which the service provider receives, and whether the service provider accepts or declines the request for service.

In examples in which multiple subregions of a geographic region are associated with different supplemental values, the activity monitor 170 can implement one or more rules or logic for determining the supplemental value for the service provider. In examples, the rules or logic may determine the supplemental value for the service provider based on, for example, the subregion(s) or location(s) where the service provider initiated performance and/or completed a specific activity. The rules or logic may determine the supplemental value using, for example, an average (e.g., weighted or otherwise) of supplemental value determinations for separate subregions, and/or a prioritization for supplemental value determinations of one subregion over another.

The PLD component 150 may determine the provisioning level for a subregion, or multiple subregions of a geographic region. In some variations, the subregions of a geographic region may be predefined. Still further, in some examples, the PLD component 150 may determine the provisioning level for a current time interval, and determine a current forecast for the provisioning level for a future time interval. The future time interval may extend from the current time to a future time (e.g., for X minutes in the future). Alternatively, the future time interval may correspond to a time interval that starts and ends in the future (e.g., between 12 pm to 1 pm each day).

As described with various examples, the system 100 may implement operations that result in a change in the provisioning level of individual subregions. The PLD component 150 may repeatedly determine the provisioning level at the current time interval and/or as a forecast for the future time interval, in order to accurately monitor and update the metrics of the provisioning levels when changes in the quantity of the service providers and/or requesters occur.

According to examples, the PLD component 150 determines the provisioning level for a given geographic region during an upcoming or future time interval based at least in part on a forecast of the number of requesters that are expected to be in the region during the upcoming or future time interval. The future time interval of the forecast may correspond to, for example, a duration of time measured from a current instance (e.g., next 10 minutes, next hour, etc.), or a duration of time that starts and stops in the future (e.g., between 12 pm to 1 pm). The estimated quantity of service providers may be determined from the historical trip data 124 for the geographic region, and a current or recent location of individual service providers.

In one implementation, the activity monitor 170 implements a “sticky” supplemental value logic 172 to the supplemental value that is used to credit each service provider. This sticky supplemental value logic 172 can provide a basis for crediting a service provider based on a supplemental value that the service provider encountered through positioning or vehicle operation over the course of a monitored activity or event, even when the service provider subsequently encountered other supplemental values while completing the same activity or event. In this context, the term “sticky” or “stickiness” is intended to mean an association that is persistent for a defined portion of the service provider's session during which one or more conditions are met. The use of sticky logic can include geographic stickiness, meaning a given supplemental value is associated with the service provider for a duration in which one or more geographic conditions are met, where the geographic conditions can specify one or more geographic constraints or regions relating to where the service provider performs activities. As an addition or alternative, the use of sticky logic may include temporal stickiness, meaning a given supplemental value is associated with the service provider for a fixed time interval, or a time interval that may otherwise be determined by one or more predetermined events. As another addition or variation, the stickiness of a supplemental value may be defined by rules, such as a rule where a supplemental value that is associated with a service provider for a service provider activity is only sticky over lesser supplemental values which the service provider encounters. While the activity monitor 170 tracks the service provider to an event that signifies completion of an activity, the sticky supplemental value logic 172, when applied, can for example, apply a single supplemental value towards determining an additive credit to the service provider's fare, where the additive credit is based on the maximum supplemental value that the service provider encountered while performing the activity or event. The map interface 168 can, for example, display the credit that is to be added to the service provider's fare, based on the sticky supplemental value determined by the sticky supplemental value logic 172 (e.g., the maximum supplemental value the service provided encountered while operating the vehicle to perform an activity or event).

In examples, service providers can receive credit that is based on the maximum service value when performing an event or activity, even when the service provider encounters lower supplemental values as the activity or event is completed. For example, a service provider may drive through subregions that credit the service provider with supplemental values that correlate to 1 unit, 3 units, 8 units, and 2 units while the service provider accepts a service request when s/he is in a subregion that credit the service provider with 4 units. In an example, upon completion of the service request, the service provider receives credit that is based on the maximum supplemental value the service provider encountered while performing activities of driving through specific regions while waiting for a service request assignment, then accepting and/or fulfilling the service request assignment.

In examples, the map interface 168 can display a supplemental value set that reflects values for individual subregions, and the PLD component 150 can repeat its operations to update the determined supplemental value set of the map interface 168. When the supplemental value set of the map interface 168 is updated and the service provider is online, some examples provide for the service provider to retain the supplemental value set of the prior map interface 168 (without the update to the supplemental value set). Still further, in other variations, the service provider retains the higher of the old supplemental value set and the updated supplemental value set. In the latter case, for example, if a service provider has achieved a supplemental value of 5 units and the heatmap refreshes with lower values, the service provider retains the 5 units to supplement the service providers fare, which s/he can receive on completion of an event or activity (e.g., the next service request, passage of time). In addition, the service provider can still increase the supplemental value beyond 5 units if s/he drives through a higher valued subregion.

In some aspects, the updates to the supplemental value sets of the map interface 168 can be pushed to service providers at different rate, such as at a slower rate compared to the rate at which actual updates occur (6 min vs. 2 min). In other words, the service provider “locks in” the heatmap being served when s/he goes online or finishes a trip. Therefore, service providers may see different heatmaps while online at the same time if they came online at different times.

In some aspects, the activity monitor 170 also keeps track of what version of the map interface 168 and/or supplemental value set heatmap each service provider observes. For example, the heatmap can be refreshed upon the service provider completing a service request. As an addition or alternative, the heatmap can be refreshed when the service provider goes offline for more than a predetermined period of time, rejects a service request, or cancels an assigned service request.

In one implementation, the supplemental value applied towards crediting the service provider is based on (i) the service provider's off-trip movement prior to accepting a service request, or (ii) the location of the service request itself. Specifically, the service provider can receive the maximum between (1) the supplemental value accrued for the service provider before the service request was received and (2) the supplemental value for the service request location. Further, the supplemental value is locked in for the service provider once the request is accepted, and therefore the service provider may not continue to accrue surge after s/he is on his/her way to the requester.

In some aspects, the supplemental value obtained by the service provider resets in a number of circumstances. As an example, once the service provider completes a service request and receives the supplemental value by way of an additive fare amount, the supplemental value resets to zero. Second, if the service provider rejects a dispatch, goes offline for more than a predetermined period of time (e.g., 5 minutes), or switches the service provider application into a mode that is ineligible for surge benefits, the supplemental value resets to zero. Whenever there is an update with respect to the provisioning level output 153, the activity monitor 170 can update the supplemental value set of the map interface 168. On a periodic basis, the PLD component 150 can deliver the update to the supplemental value set of the map interfaces 168 to the service provider's device to be displayed on a user interface.

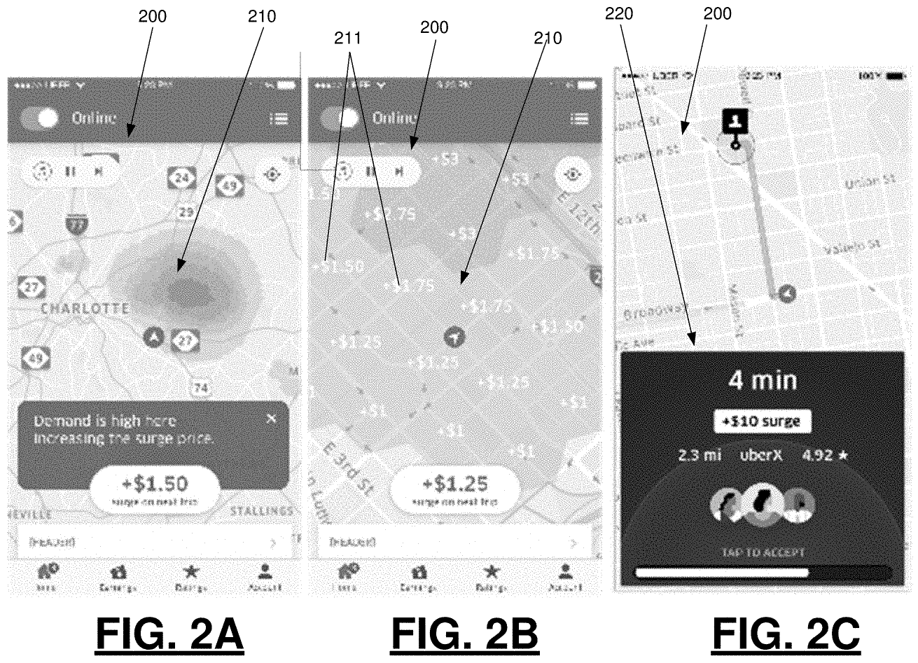

FIG. 2A through FIG. 2C illustrate an example user interface for a service provider application that is compatible with a network computer system, such as described with an example of FIG. 1. Accordingly, in examples of FIG. 2A through FIG. 2C, the user interface 200 may be generated on the provider device 102, in connection with data provided from the network computer system 100. Further, the user interface 200 may be generated in connection with service providers operating their respective vehicles in a given geographic region.

FIG. 2A and FIG. 2B illustrate a heatmap 210 of the user interface 200. The heatmap 210 may be generated on the provider device 102 using data transmitted from network computer system 100. In examples, the heatmap 210 includes cells that represent subregions of a geographic region, and each cell is provided a visual characteristic (e.g., color, shade, visual pattern, etc.) which reflects the provisioning level output 153 of the PLD component 150. Thus, the color or shading of some individual cells of the heatmap 210 may reflect a measure, degree or quantity of an estimated deficiency with respect to the number of service providers who are expected to be available for a given subregion. As with some examples, the heatmap 210 may reflect forecasted values reflecting a future time interval.

In an example of FIG. 2A, the heatmap 210 is depicted in a first view that is granular and geographically expansive (e.g., to display a geographic region). In this view, the coloring of the individual cells may combine to reflect general areas within the geographic region where the forecasted undersupply is greatest. From this view, a service provider may determine a general bearing or location to travel towards in order to receive the highest supplemental value (e.g., additive monetary compensation for service provider).

In an example of FIG. 2B, the heatmap 210 is depicted on the user interface 200 in a second view that is detailed, and focused on a set of subregions where the service provider is operating his or her vehicle. In this view, the service provider can view the heatmap 210 to view specific supplemental amounts (which are shown in an example of FIG. 2B as monetary credit) which the service provider can earn through a designated activity. As described with some examples, additive earning values 211 can reflect the supplemental amounts which the service operator can earn by performing one or more designated activities, separate from fulfilling an assigned service request. The additive earning which the service provider may earn can be conditioned on future events, such as the service provider accepting and/or fulfilling a subsequent service request once the service provider performs the activity that associates the additive earning value 211 with the service provider. The system 100 may credit an account of the service provider with a credit that is based on the additive earning value 211 which the service provider is determined to have earned, and the credited amount would be in addition to the service provider's earning for fulfilling a subsequent service request. Thus, the credited amount to the service provider for the additive earning value may be independent of distance traveled or time of travel.

In examples, the system 100 may monitor, for example, the position of the service provider when the service provider is available (e.g., not currently assigned to a service request, completing an existing service request, etc.), and the activity monitor 170 may determine the additive earning value 211 which is credited to the service provider when a designated event occurs. The designated event may signify, for example, that the service provider's activity has been completed (e.g., service provider operates vehicle until service request is assigned or accepted). While the service provider operates the vehicle, the heatmap 210 may display additive earning values 211 for different subregions in which the service provider operates in. The additive earning values 211 may motivate or otherwise influence the service provider to be positioned at or closer to subregions where undersupply is forecast to be greatest. In some examples, the activity monitor 170 may determine the additive earning value 211 using the sticky supplemental value logic 172. For example, the additive earning value 211 that is assigned to the service provider can be the highest additive earning value 211 which the service operator encountered while the service operator was operating the service vehicle and waiting for a service request. In such an implementation, the service provider is motivated to drive towards and through the subregions which are forecast to be the most undersupplied.

Once the service provider accepts and/or fulfills a service request, the service provider may be credited for the additive earning value 211. In examples, the system 100 may further implement logic where the service provider loses the additive amount (or has it reduced) if the service provider does not accept a subsequent service request. In this way, the service provider is motivated to operate his or her service vehicle to facilitate provisioning forecasts of the system 100, and further to motivate and compensate the service provider for accepting and fulfilling service requests which may otherwise be less attractive to the service provider.

In FIG. 2C, the provider device 102 may be triggered by the system 100 to display, as part of the user interface 200, a supplemental activity completion notification 220. The supplemental activity completion notification 220 may be triggered in response to, for example, an event that signifies the completion of the user's activity (e.g., the user being assigned to, or accepting a service request). In examples, the supplemental activity completion notification 220 may display the additive earning value 211 which is to be credited to the service provider upon the service provider completing an assigned service request.

Methodology

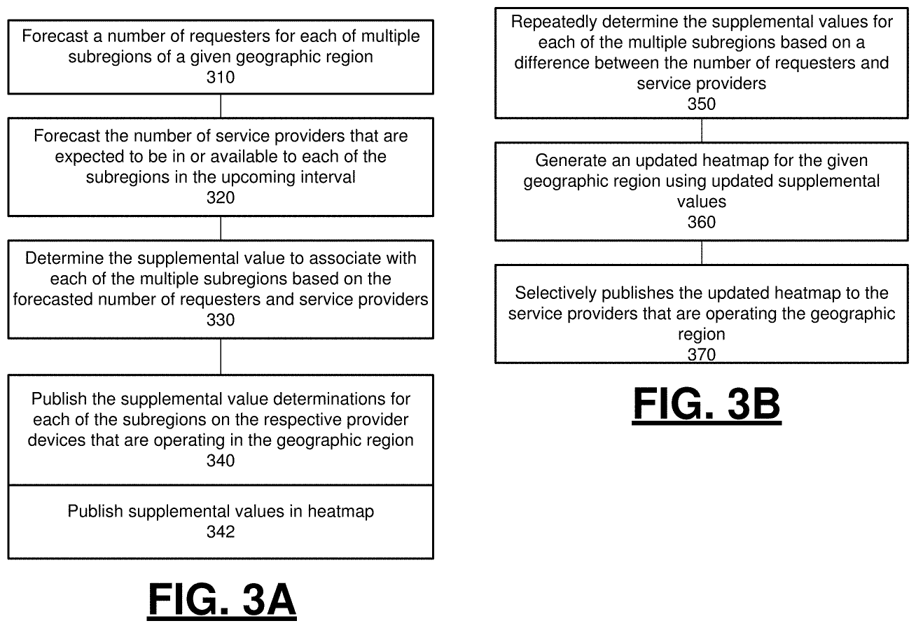

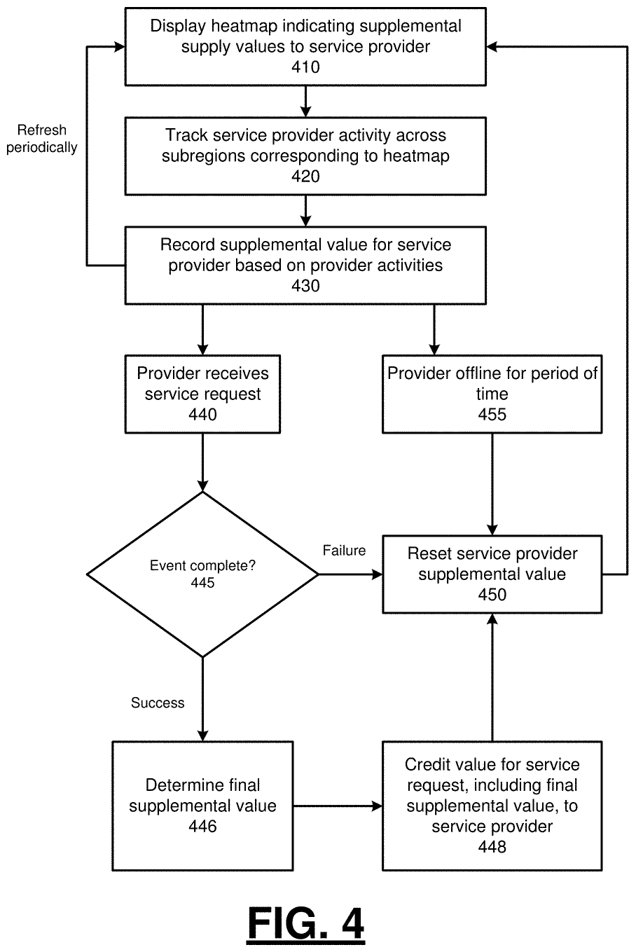

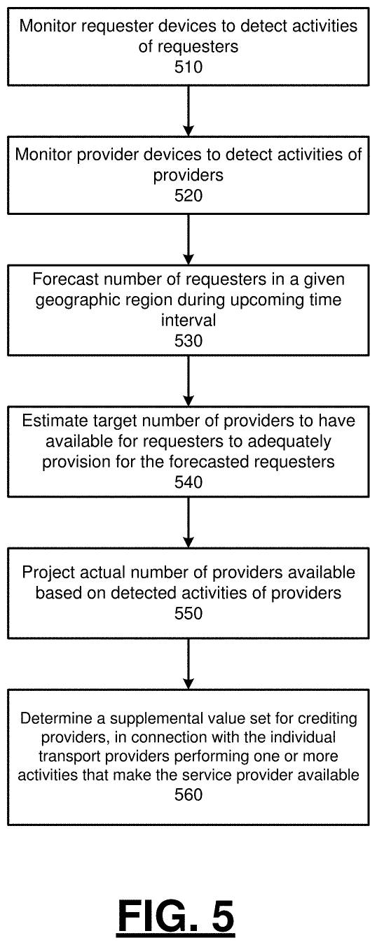

FIG. 3A and FIG. 3B illustrate example methods for providing information about supplemental values associated with corresponding subregions in a given geographic region, where the supplemental values are based on a forecasted deficiency in the provisioning of the corresponding subregion. FIG. 4 describes an example method of providing additive service values for service providers, in accordance with some aspects. FIG. 5 describes an example method of supply forecasting in a decoupled, provider-based additive reward system, in accordance with some aspects. In describing examples of FIG. 3A, FIG. 3B, FIG. 4 and FIG. 5, reference may be made to elements of FIG. 1 and FIG. 2A through FIG. 2C to illustrate suitable components or elements in connection with the performance of a step or sub-step being described.

With reference to an example of FIG. 3A, the system 100 operates to forecast a number of requesters for each of multiple subregions of a given geographic region (310). By way of example, the system 100 may forecast 4 requesters for one subregion (e.g., suburb), and 50 requesters for another subregion (e.g., downtown), with the forecast being applicable for an upcoming time interval (e.g., next 15 minutes).

Additionally, the system 100 may operate to forecast the number of service providers that are expected to be in or available to each of the subregions in the upcoming interval (320).

The system 100 may operate to determine the supplemental value to associate with each of the multiple subregions based on the forecasted number of requesters and service providers (330). The supplemental value may reflect the additive credit which the service provider can receive for performing a given positioning activity (e.g., driving to or through a given subregion while awaiting to receive a service request). In examples, the supplemental value determinations for the individual subregions may be based on a difference between the number of forecasted requesters and the number of forecasted service providers. As an addition or variation, the supplemental value determination for the individual subregions may be based on a comparison, amongst the individual subregions, of the number of requesters that are forecasted to be in each of the subregions. In this way, the supplemental value determination associates higher values to subregions where a greater quantity of service providers are forecasted as being needed. The supplemental value determination may thus be greater for a subregion where a greater number of service providers are forecasted as being needed, as compared to another subregion where a lesser number of service providers are forecasted as being needed, even though the ratio of requests to service providers may be the same for each of the multiple respective subregions.

In examples, the system 100 publishes the supplemental value determinations for each of the subregions on the respective provider devices that are operating in the geographic region (340). In examples, the system 100 publishes the heatmap 210 which associates each subregion with a corresponding supplemental value determination (342), such as an additive earning value which the service provider can earn by performing an activity (e.g., driving through subregion until receiving an assignment). The system 100 may publish the heatmap 210 by transmitting updated heatmap data to the individual service provider devices 102. The service applications 116 executing on the provider devices 102 generate the heatmap 210 using the transmitted data.

With reference to an example of FIG. 3B, in some examples, the system 100 may operate to repeatedly determine the supplemental values for each of the multiple subregions based on a difference between the number of requesters and service providers (350). For example, the system 100 may (i) forecast the number of requesters and providers, (ii) determine the difference between the forecasted number of requesters and service providers for each subregion, and (iii) then determine the supplemental values for each subregion repeatedly (e.g., every two minutes).

In examples, the system 100 generates an updated heatmap 210 for the given geographic region using updated supplemental values (360). The system 100 may generate updated heatmaps 210 while keeping track of prior heatmaps which were generated in a preceding time interval.

In examples, the system 100 selectively publishes the updated heatmap 310 to the service providers that are operating the geographic region (370). In examples, the system 100 selects the service providers to receive the updated heatmap based on a state of the respective service provider. For example, the service data store 130 may be used to identify which service providers in a given region or subregion receive an update to the heatmap 210. In variations, the system 100 transmits heat map data to each service provider device, and the respective service applications implement controls to suppress the updated heatmap 210 from being rendered in place of a prior version of the heatmap, based on predetermined conditions determined by the system 100.

In examples, the service provider may be provided an updated heatmap 210 upon the service provider becoming available to receive a service assignment. This may coincide with, for example, the service provider initiating a session (e.g., coming online), the service provider completing or nearing completion of a trip to fulfill an existing service request. As an addition or alternative the service provider may be provided with an updated heatmap 210 after any one or multiple conditions are met, such as the service state of the service provider changing or becoming available, or the passage of a designated time interval which may exceed the time interval under which the heatmap 210 is updated.

To illustrate, in some examples, the service provider may be provided the updated version of the heatmap 210 upon the service provider being available. Further, while the service provider is available, the service provider may receive updated heatmaps 210 at a frequency of once every Y (e.g., 6 minutes), while the heatmap 210 is updated and published to other service providers at a frequency of once every X (e.g., 2 minutes), where Y is greater than X. In this way, the service provider can focus and act in accordance with information communicated by the version of the heatmap 210 which the service provider receives upon becoming available. In this way, the heatmap 210 is more usable to the service provider, as the service provider is provided with fewer distractions that would otherwise result from updating the heatmap 210. As a result of updated heatmaps 210 being selectively published to service providers, different service providers may view different versions of the heatmap 210 for a given geographic region.

In conjunction with selectively publishing updated heatmaps to service providers, the system 100 may track the activity (e.g., driving route or position) of each available service provider to determine the supplemental value to associate with the service provider, using the supplemental values that are published with the version of the heatmap which the respective service provider is viewing. Thus, the system 100 may track the state of each service provider, the version of the heatmap provided to each service provider (as well as the supplemental values displayed with each version of the heatmap), and other conditions (e.g., passage of time interval Y) which can trigger the service provider to receive the most updated heatmap 210. The supplemental value that is determined for the service provider is then based on supplemental values published with the version of the heatmap 210 which is rendered to the service provider.

With reference to an example of FIG. 4, the system 100 transmits heatmap data to service provider devices 102 that operate in a given geographic region. Each provider device 102 may use the heatmap data to generate a corresponding heatmap 210, where the generated heatmaps 210 indicate supplemental supply values which are available to service providers in connection with the service providers performing corresponding actions involving the associated subregions of the respective supplemental values (410).

In one aspect, the system tracks service provider activity across subregions that are represented in the heatmap 210 (420). Still further, in variations, the system 100 tracks service provider activity for service providers that are available, or otherwise have a particular service state. For example, the activities of service providers who are operating without having a current service request assignment may be tracked. As another example, the activities of service providers who are assigned and in process of completing corresponding service requests may be tracked, as such service providers are likely to become available in a time frame during which the service provider's positioning may affect the provisioning of an undersupplied subregion.

In one aspect, the system 100 records one or more supplemental value for the service provider based on the service provider's activities (430). In examples, the supplemental values that are recorded for the service provider are based on the service provider's activities in relation to individual subregions that are associated with each of the supplemental values. In examples, the association between individual subregions and supplemental values may be defined by a heatmap 210 which is provided to the user. In variations, the association between individual subregions and supplemental values may be defined by the version of the heatmap 210 which the service provider has received and is using. Activities which may trigger the system 100 to record a given supplemental value include (i) the service provider driving into or through the subregion which is associated with that given supplemental value, (ii) the service provider positioning (e.g., driving, parking, etc.) the provider's vehicle within the subregion, or threshold distance to the subregion that is associated with the given supplemental value, (iii) the service provider operating the service vehicle towards the subregion that is associated with the given supplemental value (e.g., on a given street and in a given direction), and/or (iv) the service provider accepting a service request where one of the service locations is at or near (e.g., within a threshold distance or driving time) the subregion that is associated with the given supplemental value.

In some aspects, the service provider is assigned to, or otherwise receives a service request from the system (440). The supplemental values for the service provider may be recorded until the service provider receives the service request and/or acts on the service request (e.g., accepts the service request, picks up requester and/or completes service request).

In one aspect, the system receives an indication, either from the service provider device, service requester device, or both, that a predetermined event that is associated with the assigned service request has been completed by the service provider (445). The predetermined event may correspond to, for example, (i) the service provider arriving at, or reaching a proximity threshold of the service start location (e.g., pickup location), (ii) the service provider arriving at, or reaching a proximity threshold of the service end location (e.g., drop-off location), (iii) the service provider accepting the service request, and/or (iv) a predefined event of the service provider fulfilling the service request.

Once the predetermined event is deemed to have been completed, the system determines the supplemental value that is to form the basis of an amount to credit to the service provider. The system 100 may implement, for example, sticky supplemental value logic 172 to determine a supplemental value that is sticky. By way of example, the system can select supplemental value that is the maximum of all supplemental values which the service provider encountered while the service provider moved across subregions of the heatmap 210 (446). The system can further credit a value to the service provider for completing the service request, where the credited value is based at least in part on the supplemental value (448). The system can then reset the service provider's supplemental value (e.g., to zero) once an event is detected that indicates the service requester is once again available. Thus, the supplemental value may be reset for the next service request or until provider activity adds to the value.

If the event indicates that the service request was unsuccessful (e.g., the service provider refused the request or accepted then canceled), the system 100 can reset the service provider's supplemental value (450).

As an addition or alternative, the system can also reset the supplemental value if the service provider goes offline for a predetermined period of time (e.g., 5 minutes) (455).

In one aspect, the decoupled, provider-based additive reward system monitors a plurality of requester devices to detect activities of requesters (510).

In one aspect, the system monitors a plurality of provider devices to detect activities of transportation providers (520).

In one aspect, the system, from the detected activities of requesters, forecasts a number of requesters in a given geographic region for a transport service during an upcoming time interval (530).

In one aspect, the system estimates a target number of transportation providers to have available for requesters in the given geographic region during the upcoming time interval, to adequately provision for the forecasted number of requesters (540).

In one aspect, the system, from the detected activities of the transportation providers, forecasts an actual number of transportation providers that will be available for requesters in the given geographic region during the upcoming time interval (550).

In one aspect, the system determines a supplemental value set for credits transportation providers, in connection with the individual transport providers performs one or more activities that make the service provider available, or more likely to be available, to provide transport service for requesters in the geographic region during the upcoming time interval, wherein the system determines the supplemental values set is based on a comparison of the estimated target number of transportation providers and the projected actual number of transportation providers (560).

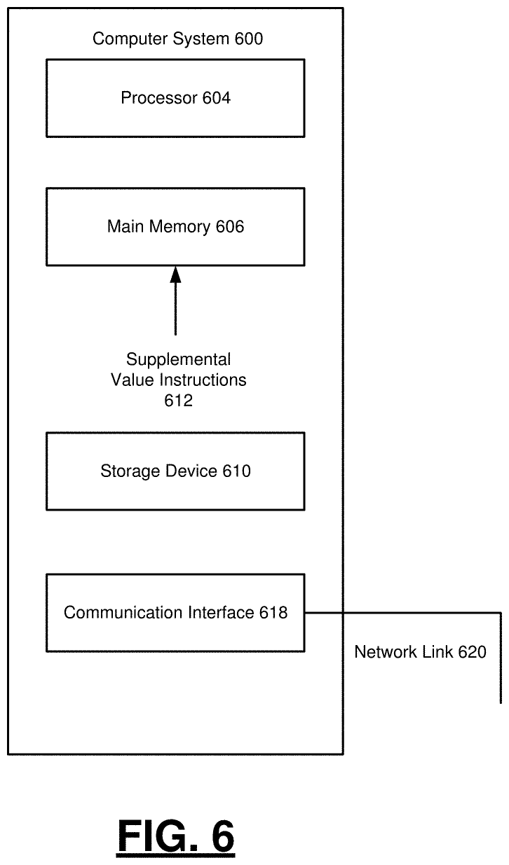

FIG. 6 illustrates a computer system upon which aspects described herein may be implemented. A computer system 600 such as described by FIG. 6 may be used to implement a network computer system such as described with an example of FIG. 1. Additionally, the computer system 600 may be operated to implement example methods such as described by FIG. 3A through FIG. 5.

In an aspect, computer system 600 includes processor 604, memory 606 (including non-transitory memory), storage device 610, and communication interface 618. Computer system 600 includes at least one processor 604 for processing information. Computer system 600 also includes the main memory 606, such as a random access memory (RAM) or other dynamic storage device, for storing information and instructions to be executed by processor 604. Main memory 606 also may be used for storing temporary variables or other intermediate information during execution of instructions to be executed by processor 604. Computer system 600 may also include a read only memory (ROM) or other static storage device for storing static information and instructions for processor 604. The storage device 610, such as a magnetic disk or optical disk, is provided for storing information and instructions such as supplemental value instructions 612. The communication interface 618 may enable the computer system 600 to communicate with one or more networks through use of the network link 620 and any one of a number of well-known transfer protocols (e.g., Hypertext Transfer Protocol (HTTP)). Examples of networks include a local area network (LAN), a wide area network (WAN), the Internet, mobile telephone networks, Plain Old Telephone Service (POTS) networks, and wireless data networks (e.g., WiFi and WiMax networks).

Examples described herein are related to the use of computer system 600 for implementing the techniques described herein. According to one aspect, those techniques are performed by computer system 600 in response to processor 604 executing one or more sequences of one or more instructions contained in main memory 606. Such instructions (e.g., supplemental value instructions 612) may be read into main memory 606 from another machine-readable medium, such as storage device 610. Execution of the sequences of instructions contained in main memory 606 causes processor 604 to perform the process steps described herein. In alternative aspects, hard-wired circuitry may be used in place of or in combination with software instructions to implement aspects described herein. Thus, aspects described are not limited to any specific combination of hardware circuitry and software.

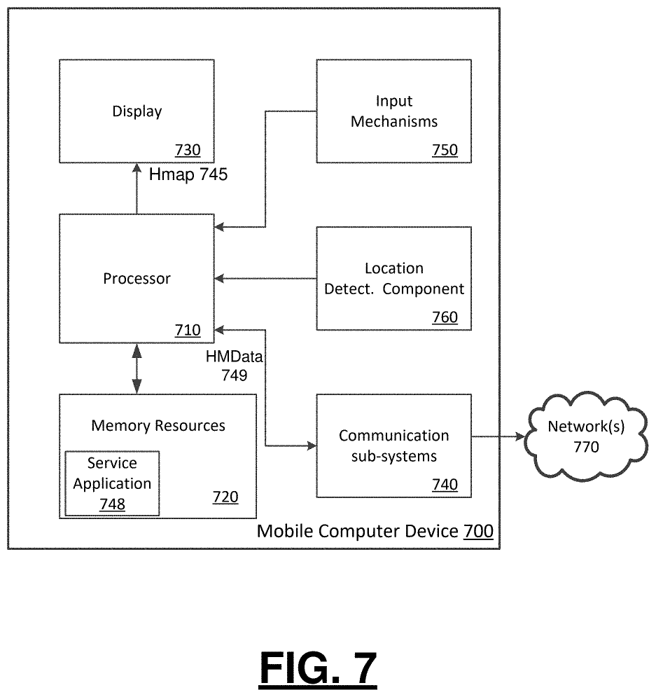

FIG. 7 is a block diagram that illustrates a mobile device upon which examples described herein may be implemented. In one embodiment, mobile device 700 may correspond to, for example, a cellular device that is capable of telephony, messaging, and data services. In other examples, the mobile device 700 may correspond to a device operated by a service provider in connection with the service provider providing transport services. Examples of such devices include smartphones, handsets, tablet devices, or in-vehicle computing devices that communicate with cellular carriers. The mobile device 700 includes processor 710, memory resources 720, display component 730 (e.g., such as a touch-sensitive display device), one or more communication sub-systems 770 (including wireless communication systems), one or more input mechanisms 750 (e.g., accelerometer and/or gyroscope, microphone, barometer, etc.), and one or more location detection components (e.g., GPS component) 760. In one example, at least one communication sub-system 770 sends and receives cellular data over network(s) 770 (e.g., data channels and voice channels). The one or more communication sub-systems 770 can include a cellular transceiver and one or more short-range wireless transceivers. Processor 710 can exchange data with a network computer system 100 (see FIG. 1) via the one or more communications sub-systems 770 and over network(s) 770.

Processor 710 can provide a variety of content to display component 730 by executing instructions stored in memory resources 720. Memory resources 720 can store instructions for service application 748. For example, processor 710 can execute the service application 748 to read data from one or more input mechanisms 750 of the computing device, and to transmit the data, along with location data of location detection component 760 as local device data to a network computer system (e.g., network computer system 100).

In examples, processor 710 can retrieve from memory resources 720 instructions for executing a service application 748. As described with other examples, service application 748 can enable an operator to receive heatmap data 749 for generating a heatmap 745 on the display 430. As described with some examples, the heatmap 745 can be dynamic and vary by time (e.g., with transmission of additional heatmap data) as well as by location of the service provider.

Although illustrative aspects have been described in detail herein with reference to the accompanying drawings, variations to specific examples and details are encompassed by this disclosure. It is intended that the scope of examples described herein be defined by claims and their equivalents. Furthermore, it is contemplated that a particular feature described, either individually or as part of an aspect, can be combined with other individually described features, or parts of other aspects. Thus, absence of describing combinations should not preclude the inventor(s) from claiming rights to such combinations.

What is claimed is:

1. A computer system comprising:
a memory to store a set of instructions;
one or more processors to access the set of instructions, wherein the instructions, when executed by the one or more processors, cause the computer system to perform operations that include:
monitoring a plurality of requester devices to detect activities of requesters;
monitoring a plurality of provider devices to detect activities of transportation providers;
from the detected activities of requesters, forecasting a number of requesters in a given geographic region for a transport service during an upcoming time interval;
estimating a target number of transportation providers to have available for requesters in the given geographic region during the upcoming time interval, to adequately provision for the forecasted number of requesters;
from the detected activities of the transportation providers, projecting an actual number of transportation providers that will be available for requesters in the given geographic region during the upcoming time interval; and
determining a supplemental value set for crediting transportation providers, in connection with each individual transport provider performing one or more activities that make the transport provider available, or more likely to be available, to provide transport service for requesters in the geographic region during the upcoming time interval, wherein determining the supplemental values set is based on a comparison of the estimated target number of transportation providers and the projected actual number of transportation providers.

2. The computer system of claim 1, wherein determining the supplemental value set is based on a difference between the estimated target number of transportation providers and the projected actual number of transportation providers.

3. The computer system of claim 1, wherein for a given transportation provider, the one or more activities includes the transportation provider operating a respective vehicle to travel towards the geographic region.

4. The computer system of claim 1, wherein for a given transportation provider, the one or more activities includes the transportation provider operating a respective vehicle to remain within the geographic region.

5. The computer system of claim 1, wherein for a given transportation provider, the one or more activities includes the transportation provider operating a respective vehicle to accept a transport request that will, when fulfilled, position the respective transport provider to be available for requesters in the given geographic region during the upcoming time interval.

6. The computer system of claim 1, wherein the instructions, when executed by the one or more processors, cause the computer system to perform operations that include:
for a given transportation provider, performing an account operation to credit the transportation provider for completing one of the one or more activities based on the supplemental value.

7. The computer system of claim 1, wherein the instructions, when executed by the one or more processors, cause the computer system to perform operations that include:
repeatedly performing (a) through (d), including determining, after at least one instance of performing (a) through (d), an update to the supplemental value set before and/or during the time interval, based on a change to at least one of the estimated target number of transportation providers or the projected actual number of transportation providers.

8. The computer system of claim 7, wherein the instructions, when executed by the one or more processors, cause the computer system to perform operations that include:
publishing, on at least a portion of the plurality of provider devices, the update to the supplemental value set.

9. The computer system of claim 8, wherein the instructions, when executed by the one or more processors, cause the computer system to perform operations that include:
for a given transportation provider that initiates performance of one of the one or more activities before the update to the supplemental value set is published, monitoring the transportation provider for completion of the activity before publishing the update to the supplemental value set on a computing device of the transportation provider.

10. The computer system of claim 9, wherein the instructions, when executed by the one or more processors, cause the computer system to perform operations that include:
causing a display of a provider device of the given transportation provider to display the supplemental value set without the update.

11. The computer system of claim 9, wherein the instructions, when executed by the one or more processors, cause the computer system to perform operations that include:
for the given transportation provider, performing an account operation to credit the transportation provider for completing one of the one or more activities based on the supplemental value set without the update.

12. The computer system of claim 11, wherein the instructions, when executed by the one or more processors, cause the computer system to perform operations that include determining a credit value for the given transport provider, based on a value of the supplemental value set that is associated with at least one of (i) a location of the transportation provider before completion of a predetermined event, or (ii) a location of the transportation provider before completion of the predetermined event.

13. The computer system of claim 12, wherein the predetermined event is a passenger pickup.

14. The computer system of claim 12, wherein the predetermined event is a passage of time.

15. The computer system of claim 12, wherein the credit value is based on the higher of (i) the value of the supplemental value set that is associated with the location of the transportation provider before completion of the predetermined event, and (ii) a location value of the supplemental value set that is associated with the location of the transportation provider after completion of the predetermined event.

16. The computer system of claim 1, wherein the supplemental value set includes multiple values, each of the multiple values being associated with a respective subregion of the geographic region.

17. The computer system of claim 16, wherein the supplemental value set is provided with a map interface on each of the plurality of provider devices, with each of the multiple values of the supplemental value set being reflected in a portion of the map interface that corresponds to the respective subregion of the geographic region that is associated with that value of the supplemental value set.

18. The computer system of claim 1, wherein monitoring the plurality of requester devices includes detecting a number of requester devices, amongst the plurality of requester devices, in which a service application is running, without a service request having been generated from the service application.

19. A method for arranging transportation services, the method being implemented by one or more processors and comprising:
monitoring a plurality of requester devices to detect activities of requesters;
monitoring a plurality of provider devices to detect activities of transportation providers;
from the detected activities of requesters, forecasting a number of requesters in a given geographic region for a transport service during an upcoming time interval;
estimating a target number of transportation providers to have available for requesters in the given geographic region during the upcoming time interval, to adequately provision for the forecasted number of requesters;
from the detected activities of the transportation providers, projecting an actual number of transportation providers that will be available for requesters in the given geographic region during the upcoming time interval; and
determining a supplemental value set for crediting transportation providers, in connection with the individual transport providers performing one or more activities that make the transport provider available, or more likely to be available, to provide transport service for requesters in the geographic region during the upcoming time interval, wherein determining the supplemental values set is based on a comparison of the estimated target number of transportation providers and the projected actual number of transportation providers.

20. A non-transitory computer-readable medium that stores instructions, which when executed by one or more processors of a network computer system, causes the network computer system to perform operations that include:
monitoring a plurality of requester devices to detect activities of requesters;
monitoring a plurality of provider devices to detect activities of transportation providers;
from the detected activities of requesters, forecasting a number of requesters in a given geographic region for a transport service during an upcoming time interval;
estimating a target number of transportation providers to have available for requesters in the given geographic region during the upcoming time interval, to adequately provision for the forecasted number of requesters;
from the detected activities of the transportation providers, projecting an actual number of transportation providers that will be available for requesters in the given geographic region during the upcoming time interval; and
determining a supplemental value set for crediting transportation providers, in connection with the individual transport providers performing one or more activities that make the transport provider available, or more likely to be available, to provide transport service for requesters in the geographic region during the upcoming time interval, wherein determining the supplemental values set is based on a comparison of the estimated target number of transportation providers and the projected actual number of transportation providers.
